(19) United States
(12) Patent Application Publication
(10) Pub. No.: US 2007/0292204 A1
(43) Pub. Date: Dec. 20, 2007

(54) Rotating bracket

(76) Inventor: Michael P. Hackney, Center Cross, VA (US)

Correspondence Address: MICHAEL P. HACKNEY, 1795 ASHDALE RD, CENTER CROSS, VA, 22437, US

(21) Appl. No.: 11/455,395

(22) Filed: Jun. 19, 2006

(51) Int. Cl. F16C 11/00

(52) U.S. Cl. 403/93

(57) ABSTRACT

A rotating bracket device made by assembling two components 101 “(101)” and 201 “(101)” for connecting and supporting structural framing members.

A rotating bracket device that is comprised of two or more components which are capable of rotating about an axis to connect and support structural framing members having the same or different angle relationships. A rotating bracket device which can be but is not limited to use in the construction of roof systems, connecting walls to trusses, connecting walls to joists, and walls to rafters. The rotating bracket is preferably

constructed of two pieces of metal 101 and 201, each of which has two portions that are bent at right angles to a connecting surface of each to form a stirrup, U-shape, or flange forming opposed flanges which are parallel to each other and perpendicular to the connecting surface. One of the components of the rotating bracket has flanges which are bent closer to each other than the flanges of the other component. When the flanges of the larger component are bent the smaller component is permanently trapped or sandwiched inside the larger component, but both components are free to rotate. A means for securing both components of the device to structural members is incorporated in each component. The rotating bracket device also incorporates a means of securing both components to structural members and allowing one component to rotate until such a time as a homebuilder sees fit to stop the ability of rotation. A device that is capable of supporting structural members by itself or by forming a joint which has the ability to rotate and still support structural member. A device that can be secured to the angle desired by the user or rotated to an angle dictated by previous construction or site requirements.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BAKCKGROUND OF THE INVENTION

1. Field of Invention

This invention is generally related to brackets used to connect structural lumber.

2. Background

Room additions or home expansion projects usually require adding walls, floors, a roof(s), and securing them to existing construction. In order to add a roof for a new room to an existing structure, the shingles must be removed and the plywood covering the trusses removed so that additional trusses can tie into the existing trusses correctly. The prior art exposes the interior of the dwelling to the elements, and adds time to the project. Exposure of the interior of the dwelling to wind, rain, and snow can damage the dwellings walls, insulation, electrical circuits or any exposed appliances. This invention allows for the removal of singles only, thereby increasing the speed of completion of the addition while keeping the interior of the structure unexposed to the elements, while allowing for new trusses to be firmly secured. The support characteristics of the invention are improved over other fastened on supports such as the one described in Pub. No. US2003/0079433A1. dated May 1st, 2003 which does not support the new truss surface #18 shown in FIG.-8 of the publication. The invention supports new structural members on three sides including surfaces #18 in the afore mentioned publication, which supports structural members on two sides only. The invention has the ability to rotate and be secured at any required angle.

U.S. Pat. No. 5,603,580 demonstrates the usefulness of devices for fastening structural members that are perpendicular to each other. The device does not adequately support structural members that are not perpendicular to each other. An example would be in FIG. 10 of said patent, that if the two structural members #35 and #32 were required to support a vaulted ceiling requiring the surface of #35 that contacts #32 be angled, the device #38 surface #37 would add no support. This is overcome by the ability of the invention to rotate and provide support to structural members at any angle by surface 101-6 of component 101. The ability to fasten structural members intersecting at various angles is increased by the invention.

The device described in Pub. No. US2004/0079034A1 relies on surface #71 to support structural member #63. The device cannot support #63 without surface #73 which is not part of said device. Also problematic with the old art is that the device is of little value when attached to vertical structural members, such as #88 in FIG. 1. The current invention may be attached to vertical or horizontal structural members and provide support to new structural members at any angle.

U.S. Pat. No. 5,553,961 begins to address the need for a support for structural members that have the ability to rotate. The device does not have ability to fasten and support the structural members by itself. As designed and described the hinge joint should be used in pairs and assembled to structural members at a factory. Also there is no provision to limit rotation incorporated into said hinge. The present invention overcomes these shortcomings by, A) having the ability to provide a hinge, B) having the ability to support structural members, C) a means to limit rotation, D) is valuable for use at a factory or on a remote job site, E) may be mounted to any surface of a structural member and accomplish the intent of securing and support structural members, F) allow for structural members to be pre-assembled on or off site and final assembly of a dwelling completed when necessary, G) having the ability to be used in permanent home improvement or building temporary structures.

The users of the invention are not limited to use the users described.

Although all of the inventions in the reference sited were of value and previously necessary, the present invention accomplishes many of their functions and adds functions that were not previously possible. The present invention makes it possible to pre-assemble structures and quickly assemble permanent structures on a job site at later date. The hinge aspect of the invention allows for A) pre-assembled structures to be collapsed for shipping, B) the ability to support and secure structural members that intersect at varying angles, C) allows the invention to be mounted on a horizontal, vertical, or angled surfaces while supporting structural members intersecting at various angles.

Should the invention to be used to connect structural members that intersect at different angles, for example a sloping roof to a wall, the device will allow one or both of the components to rotate and accept a new structural member that may or may not be vertical, horizontal, or perpendicular to the existing structural member.

The device will also support structural members that are at right angle to each other, or are parallel to each other. The device will support and connect two structural members either of which are horizontal or vertical.

The present invention has the ability to connect walls to roofs, walls to walls, floors to walls, trusses to trusses, and so on.

The invention is composed of two pieces assembled into one device that is manufactured at a factory and may be used to construct pre-assembled structures, or used on a remote job site to provide a connection for structural members including trusses intersecting each other at various angles. The invention provides for a means of adding roofs to existing dwellings without removing existing plywood, which exposes the interior of the dwelling to the elements.

Connecting long structural members is difficult because of the need to position both ends of the member correctly while securing it. This usually requires two people. The invention secured to an existing structural member will support one end of a new structural member that is not secured to the invention while one person positions and secures the other end of the new structural member. Thereby reducing manpower needed to perform the same task.

### SUMMARY OF THE INVENTION

The invention consists of two components assembled into a single unit called a Rotating Bracket.

Research of the prior art has disclosed many weakness of the prior art. These weakness are overcome by the present invention. The ability to rotate, support, cradle unsecured lumber, and be fixed into a position desired by the user to secure structural members permanently or temporarily is of great value and easily manufactured.

The bracket invention is capable of supporting and securing structural members that are perpendicular to each other or not perpendicular to each other. Structural member may be secured to the bracket while the bracket retains the ability to rotate. The bracket also allows for the user to stop the rotation and secure the bracket and the structural members at any angle desired by the user. The ability of the bracket to support a new structural member when the bracket is attached to an existing structural member but not attached to the new member allows the user to work alone. The invention has mainly been shown in an aspect of adding roofs to existing structures. The invention will prove to be advantageous to homeowners, handymen, and carpenters during construction of dwellings. However, this is not the only use of the invention.

For example a prefabricated wall and roof system using the invention consisting of 3 or 4 or more walls could be made off site, collapsed and shipped to a site where they would be unfolded and secured in position due to the uniqueness of the invention.

In the day and age we live it is obvious that dwellings which can be shipped easily, constructed quickly and used immediately to provide shelter are of value and beneficial to mankind.

Unfortunately, we live in a time of natural disasters.

The invention described in this application allows for prefabricated dwellings to be manufactured offsite, erected quickly onsite, where there is a need to give shelter to and ease the suffering of unfortunate people.

Adding additions to ones home is a nicety. Sheltering humanity is a necessity.

It is the sincere hope of the inventor that the invention is found to be useful to man and allows for uses beneficial to mankind.

While the above description contains may specificities, these should not be construed as limitations on the scope of the invention, but as exemplifications of the presently preferred embodiments thereof. Many other ramifications and variations are possible within the teachings of the invention.

Thus the scope of the invention should be determined by the appended claim and their legal equivalents, and not by the examples given.

### BRIEF DISCTIPTION OF DRAWING

FIG. 1 shows three views of component 101 with the features of 101 numbered. Numbered features will be described in the detailed in detail description of drawing section.

FIG. 2 shows three views of component 201 with features of 201 number.

FIG. 3 shows isometric view of components 101 and 201 as unassembled components.

FIG. 4 shows three views of component 101 and 201 assembled to form the invention.

FIG. 5 shows three views of the invention rotated about the aligned axes of 101-10, 101-11 shown in FIGS. 1 and 201-10 shown in FIG. 2.

FIG. 6 shows five views of the invention with component 101 rotated about the aligned axes as described in described in [5], of FIG. 5 above. Clockwise and counterclockwise rotation is shown.

FIG. 7 shows isometric view of the invention with 101 and or 201 rotated about the axes of rotation.

FIG. 8, View A shows components 201 of the invention secured by a plurality of fasteners number 1000 to structural members 1 and 2. Component 101 is shown rotated to support structural member 3 by fasteners 1000-2 shown in DT. 1 passing thru hole 101-7 shown in FIG. 1. Component 101 is free to rotate counter clockwise. DT. 2 will be explained in the detailed explanation.

FIG. 9 shows two additional views of those shown in FIG. 8. Surface 201-3 of component 201 is parallel to structural member 1 face 1-1. Surfaces 201-1 and 201-2 are parallel to and equal distance from structural member 1 side surfaces.

FIG. 10, DT. 1 shows fasteners 1000-4 inserted thru slot 201-9 of component 201 and one slot 101-9 of component 101. View 1 shows 1000-4 fastener inserted thru one hole 201-9 one of component 201 and one slot 101-9 of component 101 in the main view. Placement of fasteners in these positions prohibit rotation of the invention. Placement of fastener in other positions that prohibit rotation is possible and will be explained.

FIG. 11 shows isometric views of FIG. 10.

FIG. 12 shows two views of the invention attached to structural members 1 and 2 in a relationship whereby the surface 201-1 and 201-2 of the invention are not parallel to structural member 1 sides.

FIG. 13, Views A and B show the invention with component 101 in View B rotated 180° from the position in View A. Views C and D show the invention attached to a vertical and a horizontal support member. View D shows component 101 rotated 90° from the position shown in View C. View D shows the new position of the horizontal support member shown in View C.

FIG. 14, View A shows component 101 with an additional optional flanges 101-12. View B shows component 201 with an additional flange 201-14. FIG. 14, View B shows component 201 surface 201-6 bent on the job site as required.

FIG. 15, View A shows the invention supporting engineered structural member 4. View B shows the invention supporting structural member 3 to vertical member 1.

FIG. 16 View A demonstrates one method of using the invention to construct an assembly of structural members. View B shows the said assembly collapsed or folded for transport or storage.

FIG. 17 contains isometric view of the invention supporting walls of a prefabricated building.

FIG. 18 contains isometric view of the invention allowing sidewalls of the prefabricated building shown in FIG. 17 to be folded for storage or transportation.

FIG. 19 contains an end view of the building of the building shown in FIG. 18.

FIG. 20 contains two views of the invention mounted to vertical structural walls 1, 2, and 3.

### DESCRIPTION OF DRAWINGS AND PREFERRED EMBODIMENTS OF THE INVENTION

The invention consists of two separate components preferably made of sheet metal. The two components are sandwiched together during the manufacturing process to form one assembly, which will be called Rotating Bracket. The sandwiching process is completed by bending flanges of one component to trap features and flanges of another component.

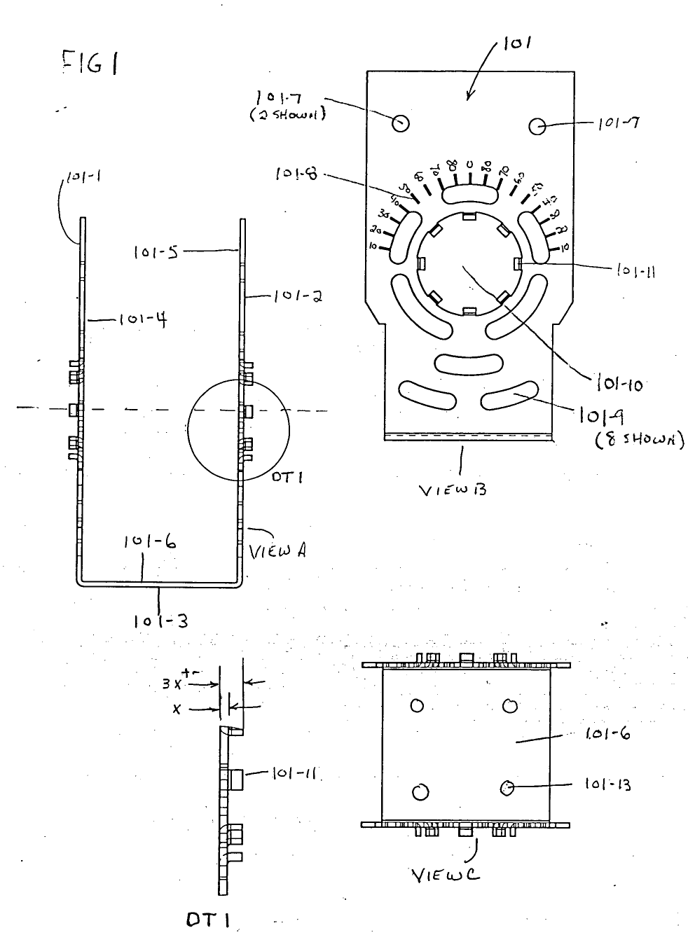

FIG. 1 shows three views A, B, and C and one detail view, DT. 1 of component 101. Said component preferably made from coiled sheet metal which is processed through a stamping die until all features are completed, or completed except for feature 101-11 shown in FIG. 1, DT. 1. Component 101 has two flanges bent at right angles which are connected, and separated by surface 101-3 and 101-6, such that surfaces 101-4 and 101-5 are mated with the offset distance determined by the width of surface 101-6. In View A, the large planner surfaces of 101 are number 101-1 thru 101-6. Surfaces 101-1 and 101-2 are parallel and are the exterior surfaces of 101. 101-1 and 101-2 have interior surfaces 101-4 and 101-5 respectively. 101-1 and 101-4 comprise one said flange 101-2 and 101-5 comprise the other said flange.

View A is the parent view for detail, DT. 1.

FIG. 1, View B shows flange surface 101-1 or 101-2, features shown are through features, identical in both surfaces and in the same position on both surfaces. Feature 101-7 is a thru hole in both said flanges that has coincident axes. Two 101-7 features are shown, the amount of reference only, the amount of said feature may be increased or decreased as desired.

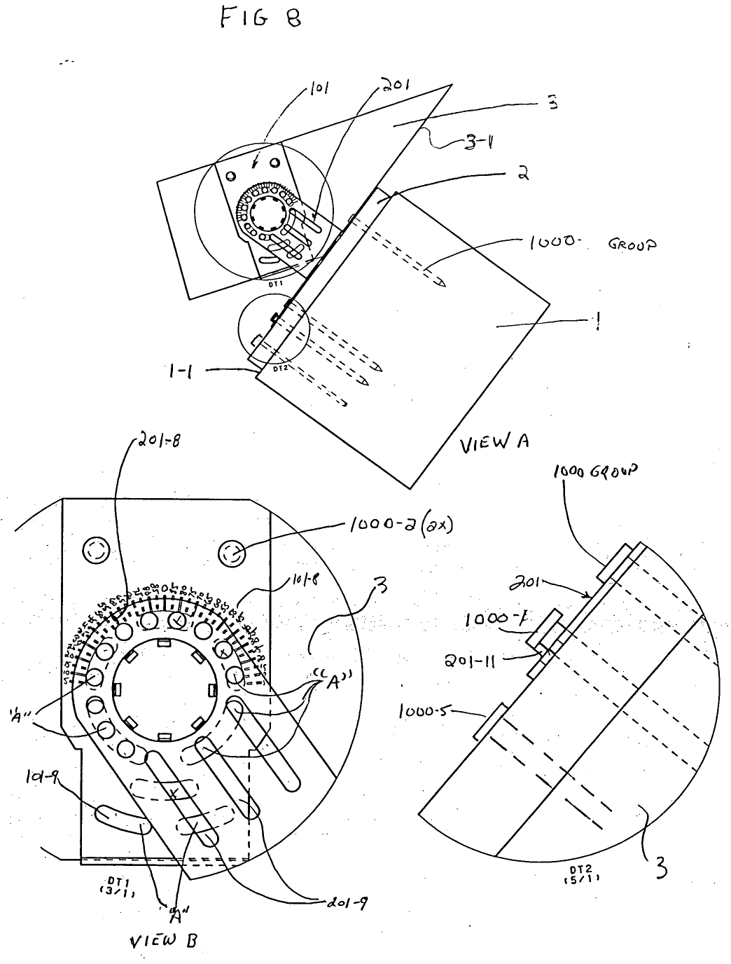

Feature 101-8 is formed by engraving punches during the stamping process. 101-8 is convenient feature that does not affect the function of the invention. Said feature will be explained in the explanation of FIG. 8.

View C shows through holes 101-13.

FIG. 1, View B, Feature 101-10 is a hole thru surface 101-1 and 101-2. Said holes having coincident axes. Feature 101-11 shown in DT. 1 is a series of teeth, protrusions or tabs formed around the circumference of 101-10.

### The tabs are formed at right angles to 101-1 and 101-2 and protrude from both surfaces approximately two times the material thickness of component 101.

### Function of all features will be explained in proceeding explanations.

### Component 101 is not difficult to manufacture.

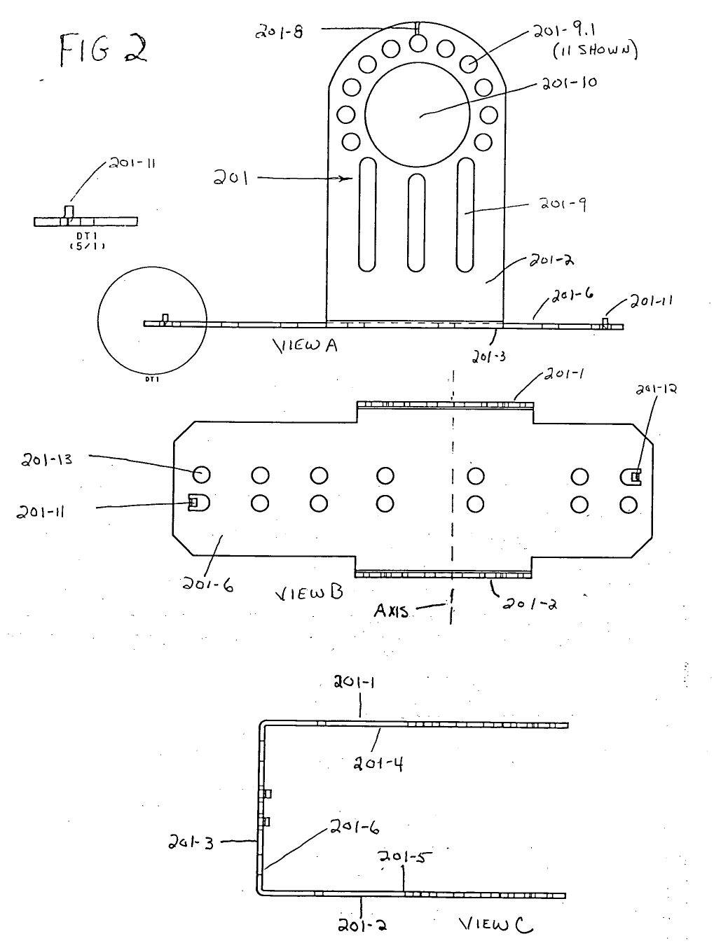

FIG. 2 shows three views, A, B, C, and one detail view, DT. 1, of component 201. 201 is preferably made of coiled sheet steel fed through a stamping die. 201 can be manufactured complete with flanged surfaces 201-1 and 201-2 bent at right angles to surface 201-3 only if the die is capable of assembling 101 and 201, if feature 101-11 of 101 was completed previously.

A secondary assembly process may be employed is to bend the flanged surfaces to right angles of surface 201-3. 201 has two flanged surfaces bent at a right angle to, connected to, separated by surface 201-3 and 201-6. Flange surfaces 201-1 and 201-2 are parallel.

View C shows the large planner surfaces of 201 numbered for clarity. Exterior surfaces threreof being 201-1, 201-2, and 201-3. The interior surfaces shown are 201-4, 201-5, and 201-6.

View A shows features that are identical in position and approximate in size. Feature 201-9 is a series of vertical slots through said flanges. Three slots are shown for reference only. 201-9.1 is a series of through holes in both flanges. Each hole in one flange has a coincident axis with a hole in the second flange, 11 of said holes are shown for references only.

201-10 is a hole through both flanges with aligned axes. Feature 201-8 and DT 1. Feature 201-11 will be explained by FIG. 8.

View B shows 12 holes 201-13. Amount of holes is for reference. Component 201 is not difficult to manufacture.

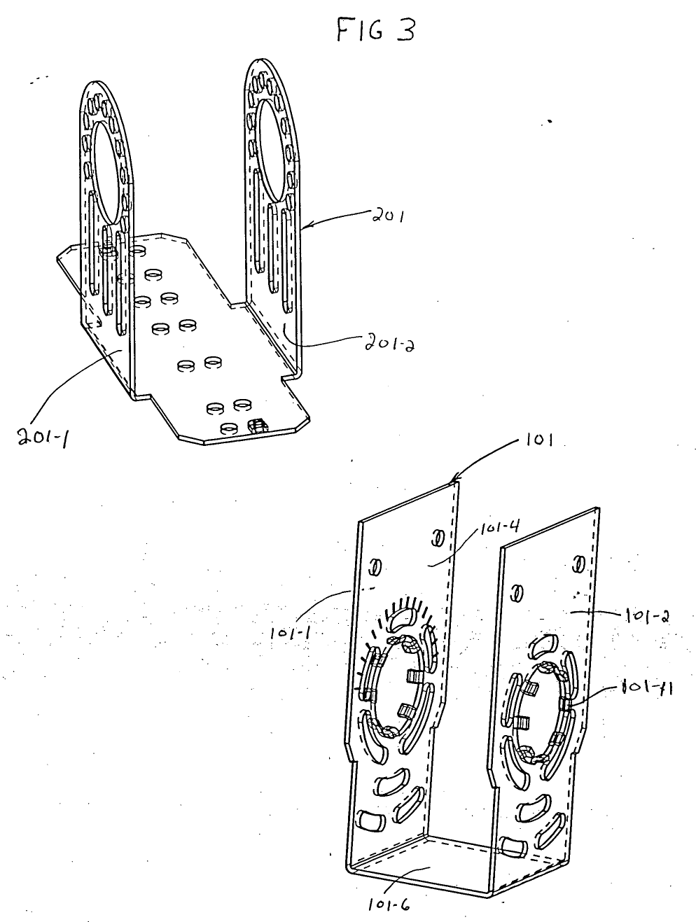

FIG. 3 shows isometric views of both 101 and 201 as separate unassembled, components in totality for reference. Either 101 features 101-11 must be flat, and parallel to surfaces 101-1 and 101-2, or 201 flanges 201-1 and 201-2 bent at less than a right angle to surface 201-6 prior to assemble of the components to form the rotating bracket.

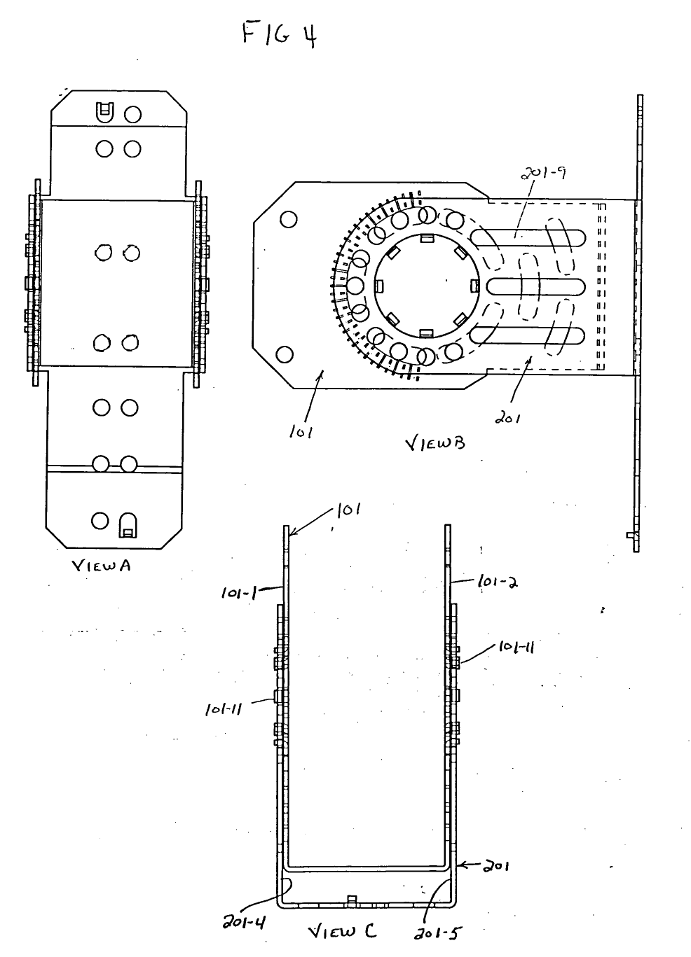

FIG. 4 contains three views of the invention assembled.

View C shows 101 trapped inside 201 by one of several methods. One such method would be placing one completely formed 101 component in an assembly fixture along with one component 201.

The two flanges, 201-1 and 201-2, which have not previously been bent to right angles would then be bent in the fixture. The fixture would position the two components accurately, so that when flanges 201-1 and 201-2 are bent at right angles the tabs 101-11 protrude through hole 201-10. After bending said flanges of 201 over the flanges of 101, the assembly of the invention is completed. Thus sandwiching the components and aligning axes of features 101-10 and 201-10 is complete. 101 and 201 may rotate, but may not be separated.

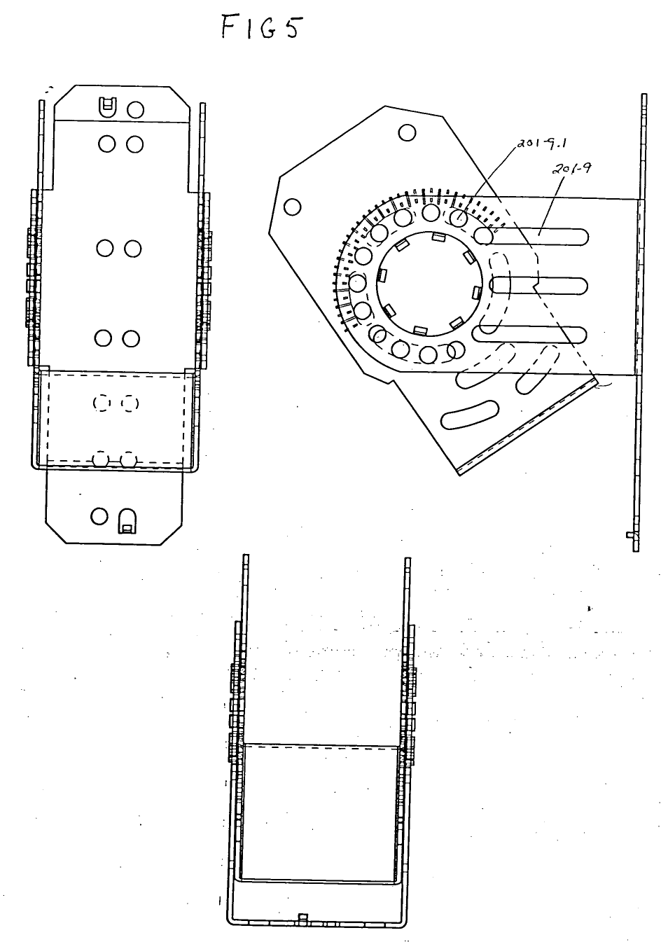

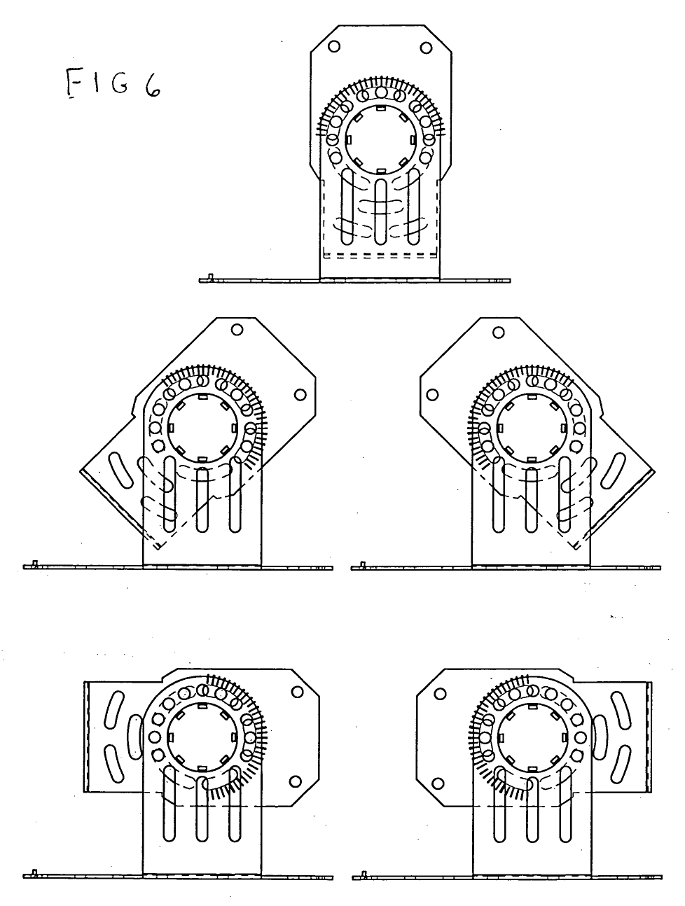

FIGS. 5 and 6 show views of the assembly with the components rotated clockwise and counter-clockwise.

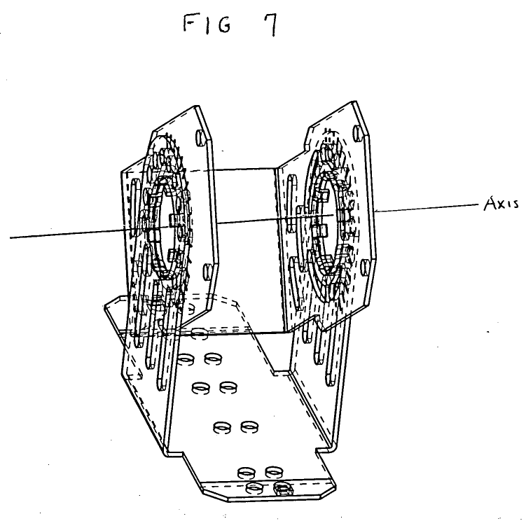

FIG. 7 shows isometric views of the invention.

FIG. 8 shows the preferred embodiment of the invention, allowing for easier construction of home additions.

View A shows the invention component 201 secured by plurality of fasteners 1000-1 group to existing structural members 1 and 2. When adding and addition to an existing dwelling it is often necessary to add a new roof that ties in and is supported by an existing roof. View 1 shows an existing structural member 1 being an existing truss. Structural member 2 is usually plywood, structural member 3 is a new truss. The prior art requires removing shingles and said plywood to expose the existing truss so that the new truss can be tied in to the existing truss.

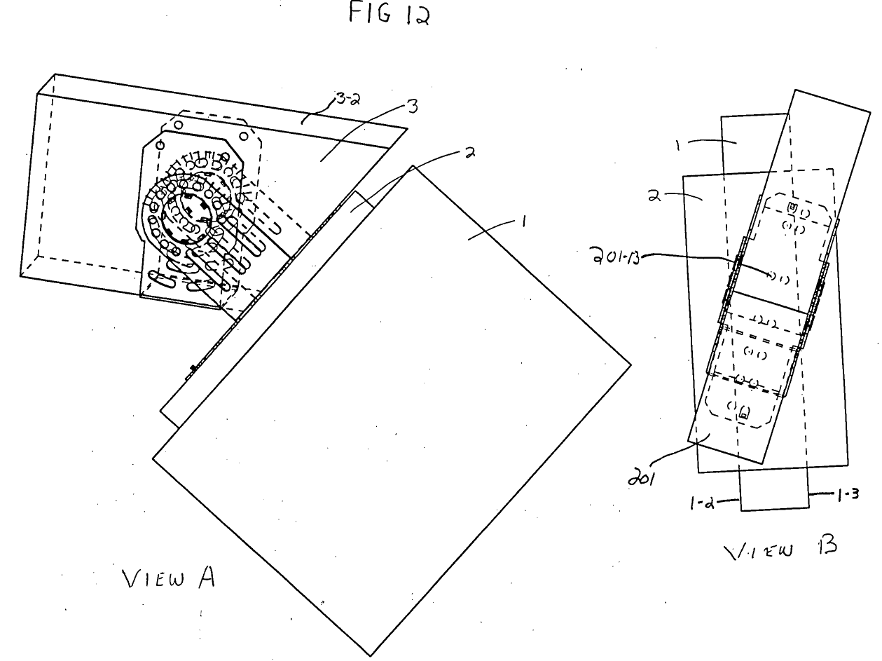

Prior art brackets or supports do not allow the bracket and the new truss to both be aligned over and supported by surface 1-1 of structural member 1 in FIG. 8, View A. Prior art supports require the removal of said plywood for them to be useful with the exception of an invention described by Pub. No. US 2003/0079433 A1, dated May 1^{st}, 2003. The improvements over said invention will be explained by FIG. 12. Removal of existing plywood adds time to the construction of the project and has at a minimum two disadvantages.

One disadvantage of the prior art is that the removal of existing plywood makes working on the exiting roof more dangerous. The second disadvantage is removal of plywood exposes the interior of the dwelling to the elements. The possibility of damage from wind, rain, snow, and animals to the exposed interior of the dwelling is increased, requiring the construction of a new roof be completed quickly, which is not always possible, or, the exposed section of the roof must be covered by some temporary, usually, not water-proof means.

Another concern is the heating and cooling loss in the dwelling during construction of an addition with the existing plywood removed when the construction cannot be completed quickly. The invention does not require the removal of said plywood while allowing for a direct tie in to existing trusses, thus the interior of the existing dwelling remains unexposed, and heating and cooling losses are kept to a minimum.

Existing roofs may be have been constructed at any angle from horizontal and an additional roof usually is constructed at another angle, a rotating bracket which can rotate to any angle and support new trusses is advantageous. When existing shingles are removed from an existing roof exposing the plywood, the location of existing trusses under the plywood is apparent from the nail pattern connecting the two. Thus, positioning and securing the invention over an existing truss without removal of said plywood is possible.

FIG. 8, DT. 2 shows an existing fastener 1000-5. The obvious location of fastener 1000-5 allows for the invention to be secured to exiting trusses without removing exiting plywood.

FIG. 8, DT. 1 shows fasteners 1000-2 (2X) in position to secure and support structural member 3 while the invention component 101 is still able to rotate. Also shown in the view is relationship of slots 201-9 and 101-9, and holes 201-9.1 with slots 101-9. Fasteners may be placed thru the invention and structural member 3 in numerous locations designated “A”, to further secure and stop rotation of the invention component 101 and member 3 as desired.

For clarity not all positions are noted, but implied.

When building the new addition to a dwelling component 201 would be secured to exiting member as desired. Structural member 3 would be placed into the invention, and onto feature 101-6 which would allow the invention to rotate while supporting the new structural member without fasteners being used. Thus, the carpenter, homeowner, handyman, etcetera. is free to work on the positioning, measuring, nailing, etcetera. other end of structural member 3. With the invention, secured to structural member 1, and the other end of the new member 3 position determined the angle to cut the new truss surface 3-1 FIG. 8 can be determine as shown in View B, FIG. 8 by checking the alignment of features 201-8 and 101-8. This feature is “user friendly” but not necessary to the function of the invention. Due to this, feature 101-8 and 201-8 will not be mentioned again in this description of the invention.

FIG. 8, DT. 2 shows an optional feature 201-11. Said feature allows for fasteners to be secured to 201 and structural member 3 for temporary construction. In the case of temporary construction, fasteners 1000-group would not be used.

FIG. 2 shows features 201-11 and 201-12 on either end of surface 201-6. Installing fasteners 1000-1 as shown in FIG. 8, DT. 1 until said fasteners contact features 201-11 and 201-12 will allow for a secure attachment while allowing the claws of a hammer room to remove the fastener when desired. If the inventions user finds the features undesirable, feature 201-11 may be flattened to be parallel with surface 201-6 by striking or bending it with any means the user wishes.

The ability to place the invention into position, securing it to exiting construction provides a secure base for new structural members while allowing the home builder and handyman to work on the other end of new trusses is the preferred embodiment of the invention.

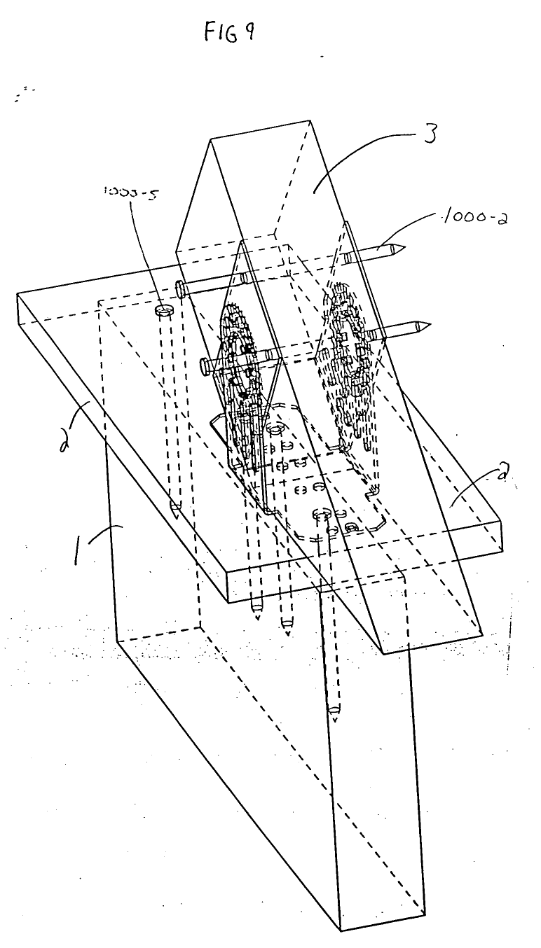

FIG. 9 shows isometric view of invention with existing fastener 1000-5. The existing structural members would have a row of said fasteners indicating the position of the truss 1, below structural member 2. Therefore allowing accurate placement of the invention. Features 1000-2 are useful for permanent or prefabricated applications.

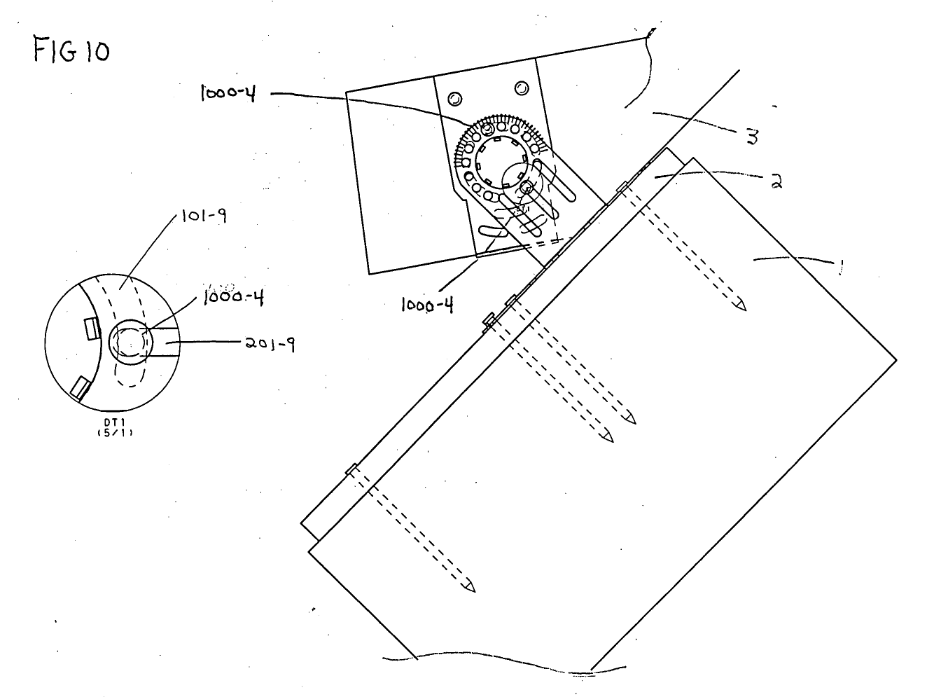

FIG. 10 shows one possible way of fastener 1000-4 to stop, secure, the ability of component 101 to rotate. By careful study of the drawing, it is apparent that many combinations of securing the invention to structural members is possible.

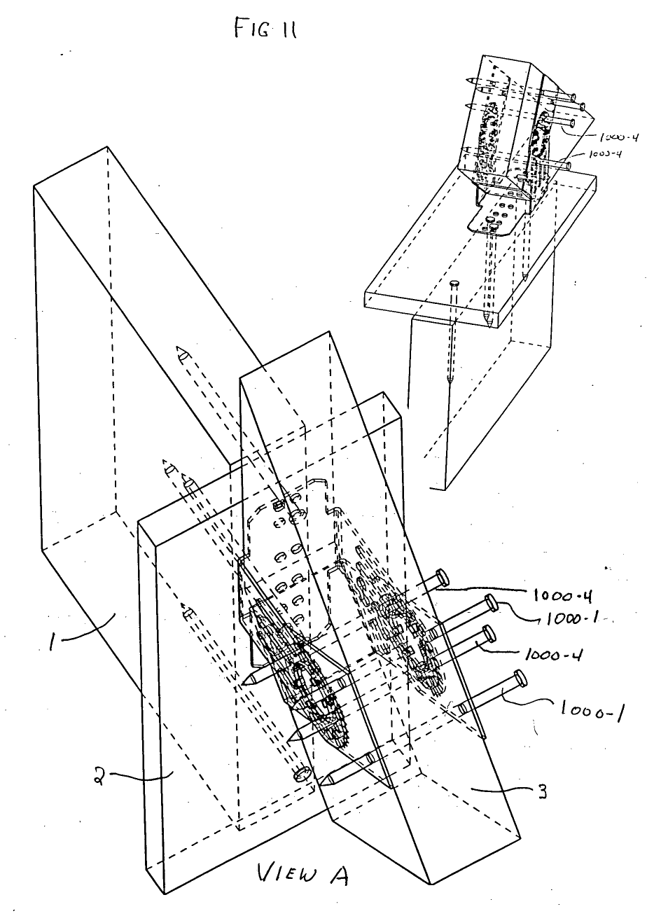

FIG. 11 is an isometric view of the preferred embodiment.

View A shows fastener 1000-4 passing through all flanges of the invention and new truss 3, thereby the above stated components are secured by the fasteners. Fasteners long enough go completely through all flanges of the invention are preferred, but not necessary.

Also shown are fasteners 1000-1. 1000-1 secure structural member 3 to the invention. Removal of 1000-4 fasteners allows for the structural members 1 and 3 to change their angle relationship. Removing 1000-4 while leaving 1000-1 attached is extremely beneficial for prefabricated buildings.

FIG. 12 shows an additional preferred embodiment of the invention positioned over the exiting truss at an angle. Said positioning would be required when the new roof and the exiting roof intersect at compound angles.

FIG. 12, View 8 shows an adequate number of hole features 201-13 in component 201 to secure the invention to exiting trusses.

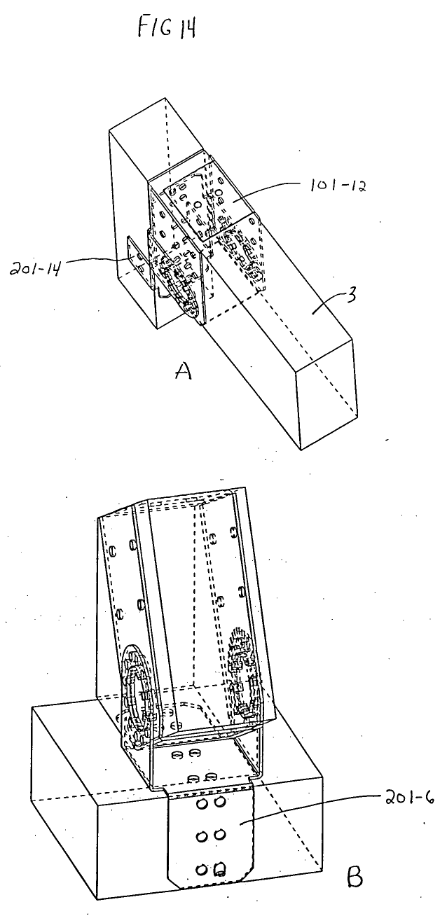

The construction of structural members is referred to as “framing”, during framing, carpenters usually wear an apron, the pockets of which are full of large “framing nails”, long enough to pass through 2×4 inch lumber and secure the lumber to other structural lumber. Nails shorter than “framing nails” are not generally used during “framing.” Patent Pub. No. US 2003/007943 A1, dated May 1^{st}, 2003 described a useful device that has room for improvement. Said framing nails are too long to pass completely through the device as doing so would spread features 7 and 8 shown in FIG. 14 of the publication rendering the device useless. Fastener 13, FIG. 14 of the publication may be readily available “common” size fasteners, but they are shorter than framing nails and require a carpenter to carry a variety of fasteners which is undesirable. The current invention allows for the use of “framing nails” due to the fact that invention incorporates features that allow a framing nail to pass through all flanges and features of the invention and the lumber. The use of “framing nails” is preferred when using the invention but not required. As shown to the document referring to the use of the device stated above there is no provision to support surface 18.

FIG. 9. shows the current invention component 101 surface 101-6 providing the support omitted in the prior art. The invention shown in FIG. 12, View A positioned at an angle to existing truss 1, supporting new truss 3, shows the surface number 3-2 of truss 3 at an angle which permits new plywood that will be attached to said surface a flat plane for support and attachment of the plywood.

### This is not accomplished by the prior art.

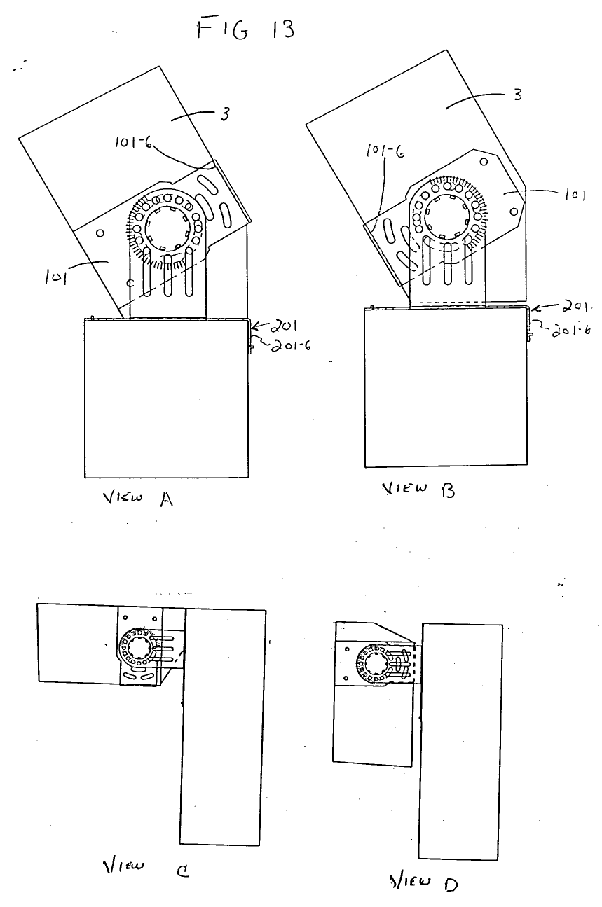

FIG. 13 shows four views of the invention supporting structural members.

View A shows component 101 rotated so that surface 101-6 is positioned to form a strap which prohibits the movement of lumber 3 in one direction. View B shows component 101 of the invention rotated 180° from the position shown in View A. Component 101 in the position shown in View B forms a cradle to support structural lumber 3.

Both Views A and B show surface 201-6 of component 201 bent at an angle if required by the user of the invention. Views C and D show the invention supporting structural members that are perpendicular to each other in View C, and rotated to be parallel in View D.

FIG. 14, View A shows the invention supporting two perpendicular members. 201-14 is an additional support feature added to 201 if required. 101-12 is an additional support feature added to component 101 if required. Said feature would trap and secure member 3 without the need for fasteners passing through 101, 201, and 3, providing the end of 3 not supported by the invention is secured or supported. View B shows surface 201-6 bent by the user of the invention if desired or required by the user.

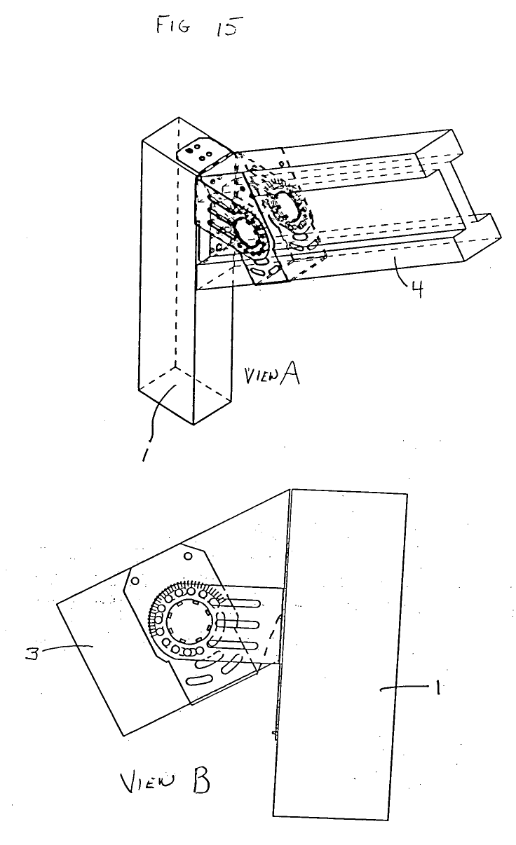

FIG. 15, View A shows the invention supporting engineered structural member 4. Engineered rafters such as shown in the view are difficult to support if they are required to be placed at an angle with respect to lumber 1 other than perpendicular.

View A shows the invention attached to lumber 1 accepting, cradling and supporting engineered lumber 4 which is at an angle that would be required form a vaulted ceiling.

View B demonstrates the preferred embodiment of the invention by of connecting new member 3 to exiting member 1 in a way that would be beneficial for adding trusses to vertical beams. The ability of the invention to rotate allows for a roof or wall to be collapsed when need for it is not present, thus saving space, and rotate into a functional position when the need arises.

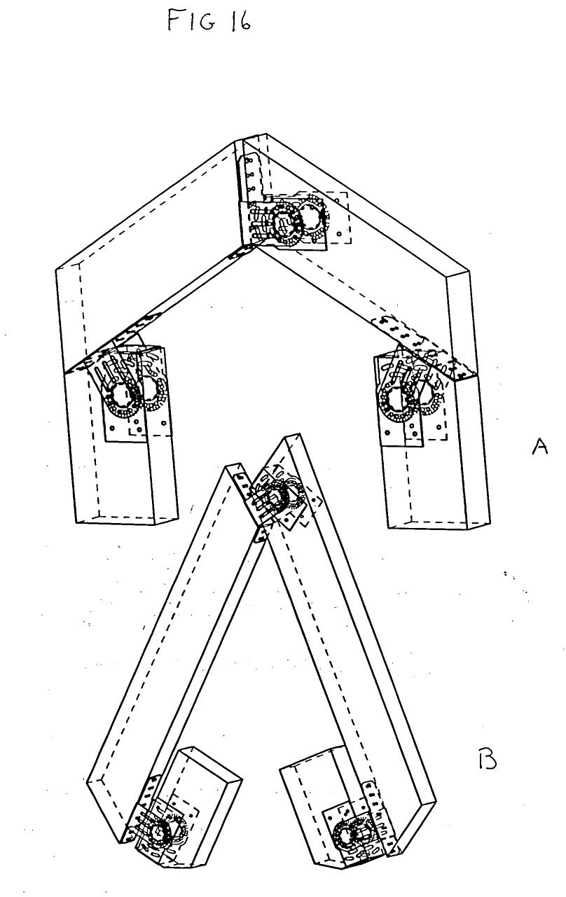

FIG. 16 shows one possible use of the invention in a prefabricated system consisting of trusses and wall members.

View A shows the system as it would appear in use.

View B shows the system collapsed for storage or transport.

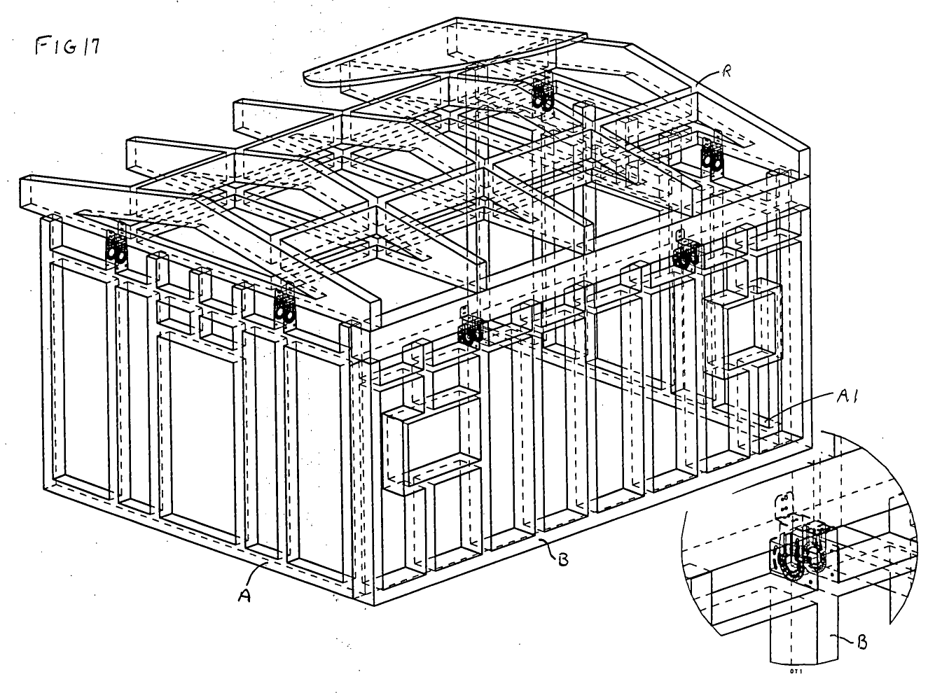

FIG. 17 shows preferred embodiment of the invention. Shown is an isometric view of a prefabricated building. Said building may consist of a roof system R, with the invention secured to said roof system in multiple locations, as shown for reference, to connect said roof to vertical side walls, A, A1, and B. Three side walls are shown for clarity. The invention would have provisions for fasteners that stop the invention's ability to rotate and lock the sidewalls into vertical position if required, or any other angles desired, as previously described. Securing the sidewalls to a floor makes the said building temporary or permanent. Removal of the fasteners securing the sidewalls to the floor and the fasteners which stop the ability of the invention to rotate allow the sidewalls to be collapsed and the building moved.

DT. 1 shows the position of the invention and sidewall B.

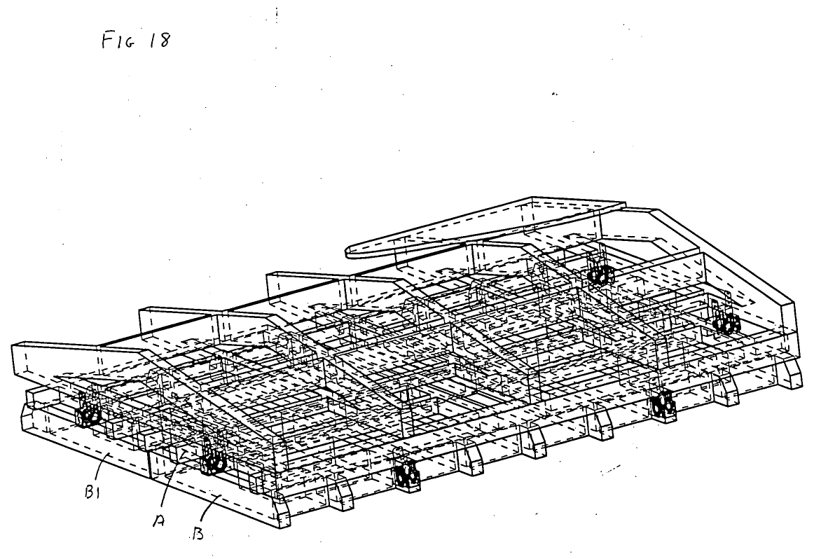

FIG. 18 shows an isometric view of the invention attached to said prefabricated building with said sidewalls folded or collapsed.

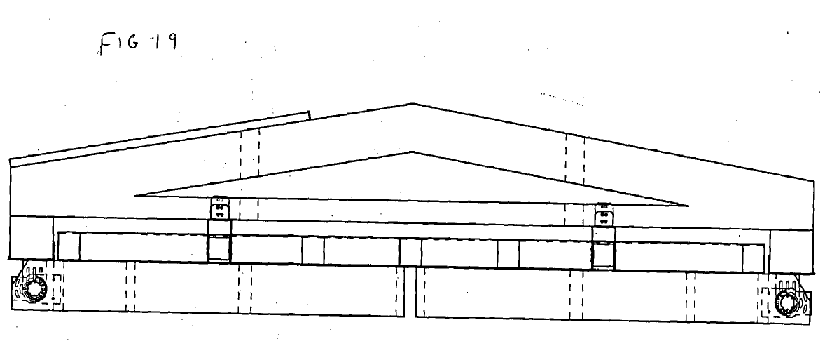

FIG. 19 shows an end view of structure shown in FIG. 19.

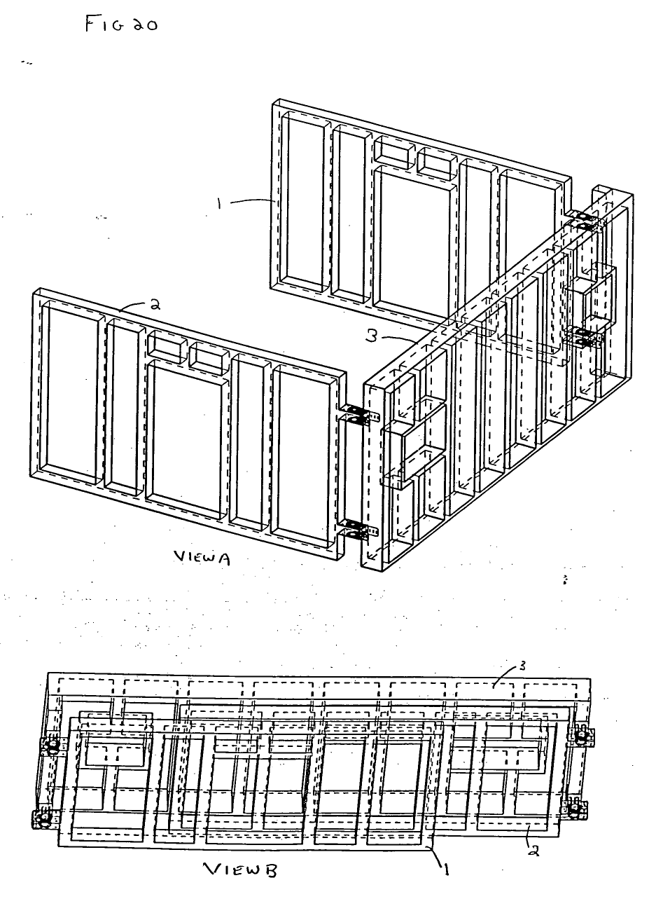

FIG. 20, two views A and B are shown in FIG. 20.

View A shows the invention secured to vertical sidewalls 1, 2, and 3.

View B the sidewalls folder or collapsed and connected to the invention.

Accordingly the reader can see the usefulness of the invention as well as the variety of uses which range from being beneficial to a homeowner adding an addition to a factory manufacturing prefabricated buildings.

What is claimed:

1. What is claimed is a rotating bracket comprised of two separate components which are assembled to make said rotating bracket, afore mentioned bracket having the ability to support and secure structural members.
A) the assembly of the components renders a bracket which has the ability to rotate.
B) each component of said bracket having provisions for securing and attaching each component to structural members.
whereby said bracket has the ability to be secured to and support structural members that are perpendicular to each other or are not perpendicular to each other.

2. A rotating bracket, the components of which when fastened to permanent or temporary structural members may rotate.

3. A Rotating bracket the components of which when fastened or secured to structural members incorporate provisions for fasteners passing through the components to stop the ability of the components from rotating,
A) said rotating bracket having the ability to rotate upon removal of the fasteners which prohibit rotation of the invention.

4. A rotating bracket the components of which may be fastened to structural members and secure the members at a variety of angles,
A) the angle relationships of structural members may be governed by the invention,
B) an invention which is adaptable to different angle relationships of structural members.

5. Said bracket has features allowing it to be fastened by fasteners to structural members for use in the permanent or temporary construction of dwellings by supporting the walls, floors, trusses, and other structural members,
A) will be used in permanent construction to secure new walls, trusses, floors, etcetera,
B) will be used in prefabricated dwellings that be erected permanently,
C) will be used in prefabricated structures that are erected temporarily,
D) contains features for easy removal of fasteners, when disassembling temporary structures,
E) can be modified by the user of the invention.

6. A bracket which will be constructed in a method that limits the need for additional fasteners to support structural members.
A) wherein features of one of the invention adequately support and secure said members without fasteners securing said member to the invention,
so that the speed of constructing temporary or permanent dwellings is increased.

7. A bracket containing features which allows for assembly and disassembly of dwellings or structures, while the bracket remains fastened by fasteners and attached to structural members such as floors, walls, and trusses,
A) a bracket attached to structural members which has features that allows for fasteners to form a permanent attachment to structural members,
B) features incorporated in the brackets allow for adding or removing fasteners securing the bracket and structural members, said fasteners prohibiting rotation of the bracket and the structural members,
whereby allowing for erection of said structure at a site desired by the user
while allowing means for disassembling said structure.

8. A rotating bracket which connects to and supports two or more structural members that may have varying angle relationships,
A) the aspect of the members secured by the invention having the ability to be parallel for storage or transportation,
B) the structural members will be rotated to change the angle relationship,
thereby the invention processes great flexibility possible uses thereof.
The claims as stated provide the basic uses of the invention. The invention is not restricted to or by the stated claims. Different use of the invention and the methods of constructing the invention may be altered as desired without changing the intent of the invention.
